(19) United States
(12) Patent Application Publication
(10) Pub. No.: US 2011/0108619 A1
(43) Pub. Date: May 12, 2011

(54) FUNCTIONALITY MANAGEMENT IN MOBILE DEVICE

(75) Inventor: Sture Udd, Vaasa (FI)

(73) Assignee: UPC KONSULTOINTI OY, Vaasa (FI)

(21) Appl. No.: 13/002,075

(22) PCT Filed: Jul. 3, 2009
(86) PCT No.: PCT/FI2009/050608

§ 371 Date: Dec. 30, 2010

(30) Foreign Application Priority Data
Jul. 30, 2008 (FI) 20085750

(51) Int. Cl. G06F 17/00

(52) U.S. Cl. 235/375

(57) ABSTRACT

An apparatus comprising means for processing data representative of an optically readable code, means for detecting, from the data representative of the optically readable code, a timer indicator indicating that the code includes data for implementing a timer on the apparatus, one or more timer parameters, and means for running the timer on the apparatus on the basis of the detected one or more timer parameters.

### FIELD

The invention relates to functionality management in a mobile device.

### BACKGROUND

Mobile stations, such as mobile phones, may interact with each other and other network devices via a mobile communication network. The communication of the mobile stations via the mobile communication network is so characteristic of the mobile stations that this approach continues to be dominant despite some evident deficiencies.

The availability of a communication network based service may be dependent on several factors, such as the operation of the communication network serving the mobile station, the operation of a data communication network such as the Internet, or the operation of a server operating in the communication network and providing service to the mobile station.

### SUMMARY

In an aspect, there is provided a mobile station comprising means for reading data representative of an optically readable code. The mobile station further comprises means for detecting, from the data representative of the optically readable code, a timer indicator indicating that the code includes data for providing a timer on the mobile station, means for detecting, from the data representative of the optically readable code, one or more timer parameters including at least one parameter defining a time of the day, means for applying the one or more timer parameters including at least one parameter defining a time of the day to directly define one or more expiry moments of the timer, and means for running the timer on the mobile station on the basis of the defined expiry moments of the timer.

In another aspect, there is provided a method comprising reading an optically readable code. The method comprises detecting, from the data representative of the optically readable code, a timer indicator indicating that the code includes data for providing a timer, detecting, from the data representative of the optically readable code, one or more timer parameters including at least one parameter defining a time of the day, applying the one or more timer parameters including at least one parameter defining a time of the day to directly define one or more expiry moments of the timer, and running the timer on the basis of the defined expiry moments of the timer.

### DRAWINGS

In the following the invention will be described in greater detail by means of preferred embodiments with reference to the accompanying drawings, in which

FIG. 1 shows an embodiment of an arrangement;

FIG. 2 shows an embodiment of an apparatus; and

FIG. 3 shows an embodiment of a method.

### DESCRIPTION OF SOME EMBODIMENTS

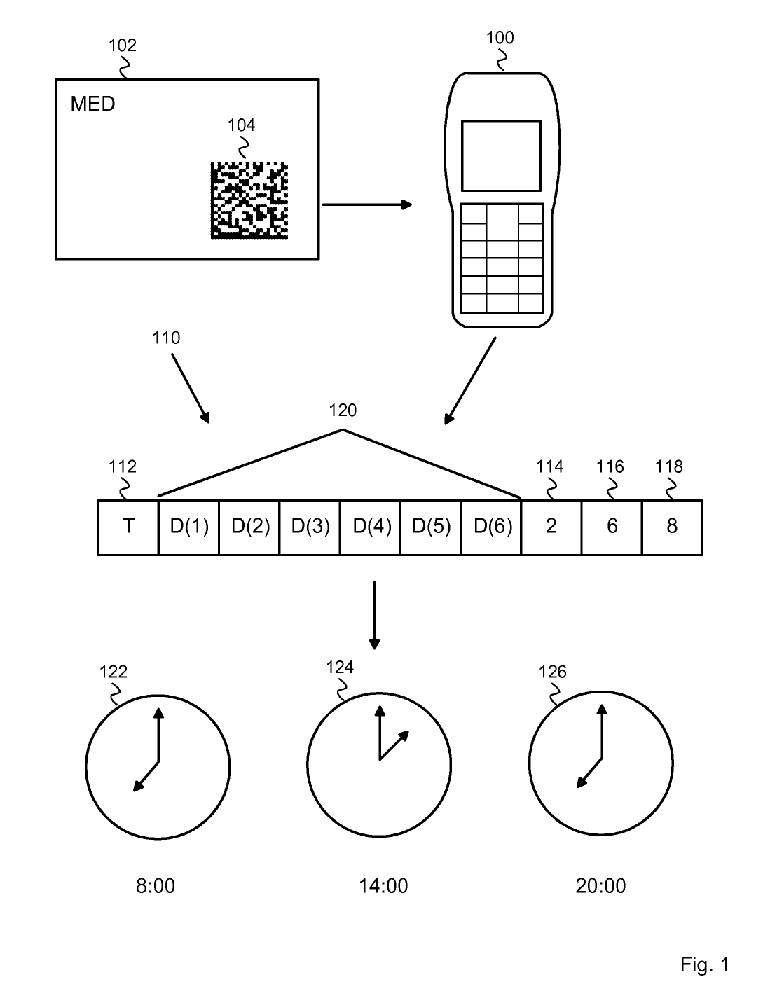

FIG. 1 shows an embodiment of an arrangement. The embodiment shows a mobile station 100. The figure also shows a medicine package 102. On the cover of the medicine package, an optically readable code 104 is attached or printed. The optically readable code may be a data matrix code or a so-called smart code, for instance.

The mobile station includes a functionality for reading or scanning the code 104. The functionality may include a built-in camera and a software functionality for interpreting the information in a photo of the code taken with the camera. The mobile station may also be capable of providing actions on the basis of the interpreted information.

The middle part of FIG. 1 shows a data structure 110 including the information extracted from the optically readable code 104. The software functionality in the mobile phone may thus form a set of symbols from the code 104. The set of symbols may be a string of characters, for instance. In the example of FIG. 1, the data structure includes ten positions and one character may be placed into each position of the structure.

The data structure 110 may include a timer indicator 112 for indicating that the code relates to implementation of a timer. The timer indicator may be an ASCII character “T”, for instance. In the timer functionality, time may be counted up or down and when the timer expires, an alarm may be given.

The timer indicator may be positioned in a predetermined position of the data structure. For instance, the mobile station may look for a timer indicator from the first character position 112 in the data structure 110. Thus, upon reading the code 104, the mobile station may find the character “T” in the first position, whereby the mobile station becomes aware that the code relates to the timer functionality.

The data structure 110 may include further timer parameters 114, 116 and 118 in predetermined positions in the set of characters extracted from the data matrix code 104. When the mobile station has identified the timer indicator 112, the mobile station may know that further timer parameters are located in positions 8, 9 and 10 in the data structure, for instance. The rest of the positions 120 may each include one character for other possible purposes in the use of the code data.

The timer parameter in the eighth position 114, for instance, may include a function indicator, which may have values from 1 to 9 and identify a sub-function in the timer functionality. As an example, a sub-function value “1” may indicate that the timer should expire every 6 hours. A sub-function value “2” may indicate that the timer should expire 3 times a day but not during the night. A sub-function value “3” may indicate that the absolute values when the timer should expire are provided for in some predetermined positions, known to the mobile station, of the data structure 110. Such a predetermined position may include the last positions 116, 118 and/or one or more of the central positions 120.

Instead of the sub-function indicator in the position 114, all the fields 114 to 118 may include absolute expiry moments, that is, the time of the day of the expiry of the timer.

Thus, based on the data read from the optical code, the mobile station may directly, without user interaction, form all the expiry moments of the timer. For this purpose, the optical code includes at least one time moment of a day, such as 10:00 am, for instance. The given time moment may also be an expiry moment itself, or it may be a time value serving only as a basis for calculating the expiry moments. Based on this one time moment of the day, the expiry moments of the timer may be defined relatively to the given moment of time. That is, the code may include a relative parameter, such as 6 hours, defining the expiry interval. One expiry moment would thus be 16:00, that is 6 hours from 10:00.

The example in FIG. 1 may relate to giving an alarm at moments when a person should take his/her medicine. Upon reading the code, the mobile station may start interpreting the contents of the code. The first position 112 includes a character “T” indicating that the code relates to the timer functionality. The eighth position 114 in the data structure 110 includes a sub-function indicator “2” meaning that the timer should expire three times a day excluding the night. The ninth position 116 indicates the interval in hours, that is 6 hours, when the person should take the medicine. The tenth position 118 includes the time of the day of the first expiry of the timer.

As a result, three moments of time may be identified when the timer should expire. The first expiry 122 occurs at 8:00 as indicated by the character 118 in the data structure. The following expires 124, 126 take place at 6 hours intervals at 14:00 and 20:00. The mobile station 100 may give a sound indication to the person at the expiry of the timer.

There may be several simultaneously ongoing timers on the mobile station, one for each medicine used by the person, for instance. The person may give a feedback indication to the mobile station if he/she has taken the medicine. If the person fails to provide the feedback indication, the mobile station may continue reminding the person to take the medicine and/or give the feedback indication.

Although FIG. 1 refers to a data matrix code, any other optically readable code may be applied for the same purpose. Instead of a mobile station, the device reading the code may be any device capable of reading an optically readable code.

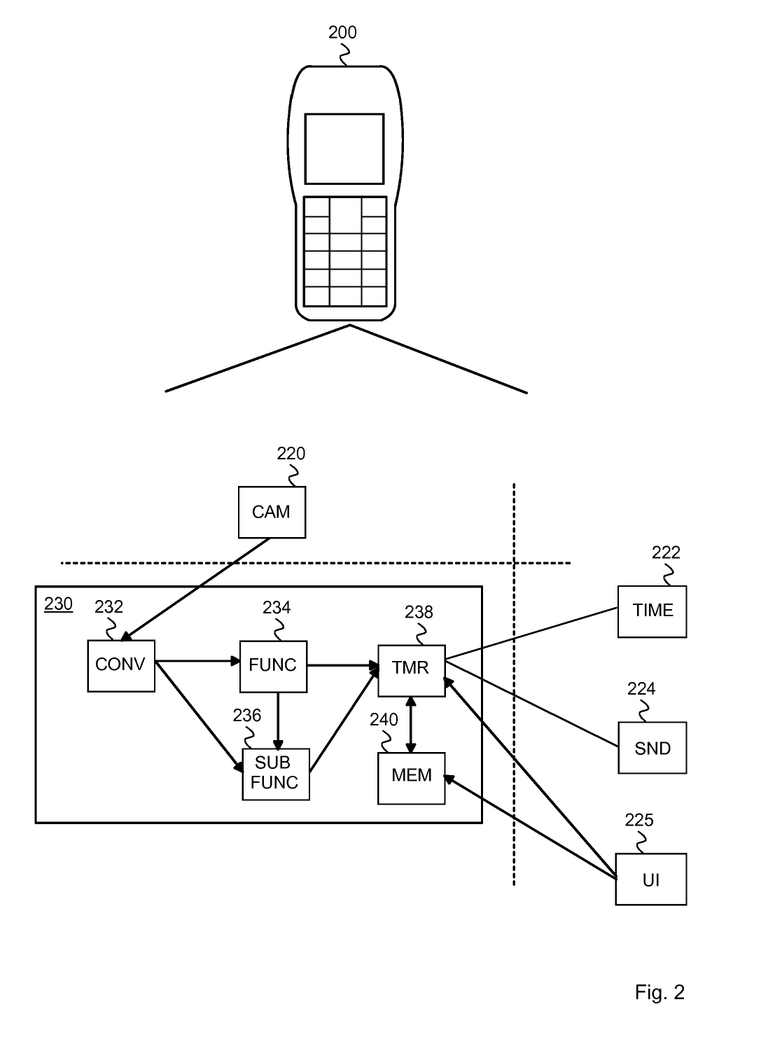

FIG. 2 shows an embodiment of a device 200, which may be a mobile station, for instance. The mobile station 200 includes reading means 220 for reading/scanning an optically readable code. The reading means may include a built-in camera. The mobile station may also include a general time management unit 222, which may a part of a standard mobile phone. An interface shown by the dashed line may be provided, over which the time management unit 222 may provide services for applications needing a time management functionality. As an example, the application 230 may request a signal every second, minute or hour, for instance. The application may then implement a clock by counting the signals received from the time management unit 222. For instance, upon receiving three hourly signals from the unit 222, the application knows that three hours have elapsed.

The mobile station may also include a unit 224 for giving a sound indication. The application 230 may send a request over the interface shown by the dashed line to provide a sound indication. The sound may then be given via a loudspeaker of the mobile station 200.

The application may include a converter 232 for converting a data matrix code read by the camera 220 to a set of characters. The set of characters may include a string of ASCII characters, for instance. The application may further include a function identifier 234. The function identifier may, for instance, search for the character “T” from a predetermined position of the set of characters provided by the converter 232 to indicate the timer functionality.

The application may also include a sub-function identifier 236. The sub-function identifier may identify, from the set of characters, further parameters needed to implement the timer functionality. One of these further parameters may be the number of repetitions of the timer. For instance, there may be a need to repeat the timer 10 times. Furthermore, as yet another parameter, an identifier of the timer may be provided. A person may have several medicines to take, and there may be a need to have an indicator to identify which medicine should be taken upon the expiry of the timer.

Finally, the information of the timer functionality and further parameters to implement the timer functionality may be passed over to the timer unit 238. The timer unit may practically implement the timer functionality by using the time management functions 222 of the device 200. Although FIG. 2 shows only one timer functionality, there may be a plurality of timer functionalities ongoing simultaneously. Their operation may be independent of each other. Alternatively, the operation of several timers may be integrated according to a predetermined heuristics. For instance, if the person has two medicines to take and the timers of those would expire at one hour interval, the timer 238 may provide an alarm for both timers after 30 minutes from the first expiry so as to minimize the number of alarms.

In an embodiment, the apparatus of FIG. 2 may be used for reminding a person to take a medicine. The timer unit 238 may provide a timer to give an alarm at 8 hours interval. For this purpose, the timer 238 monitors the time and uses the sound giving devices 224 to provide a sound indication to the person. In conjunction with the sound indication, the display of the device may indicate which medicine should be taken.

The device also includes a user interface 225, which may include a keyboard and/or a touch screen of the device, for instance. The user may indicate by pressing a key on the keyboard that he/she has taken the medicine. This information may be stored in a memory in the application 230. This information or the lack of it may have several consequences in the application. First of all, if the person fails to take the medicine and press the key, the device may continue giving alarms until the person confirms the taking of the medicine. The memory may also store the number of medicines taken by the person. From this information the unit 238 knows how many times the timer functionality still has to be implemented.

The application 230 may be loadable and storable onto the mobile station and may be external to the standard functionality of the mobile station. The application may be implemented by means of software and loaded on a processor of the mobile station.

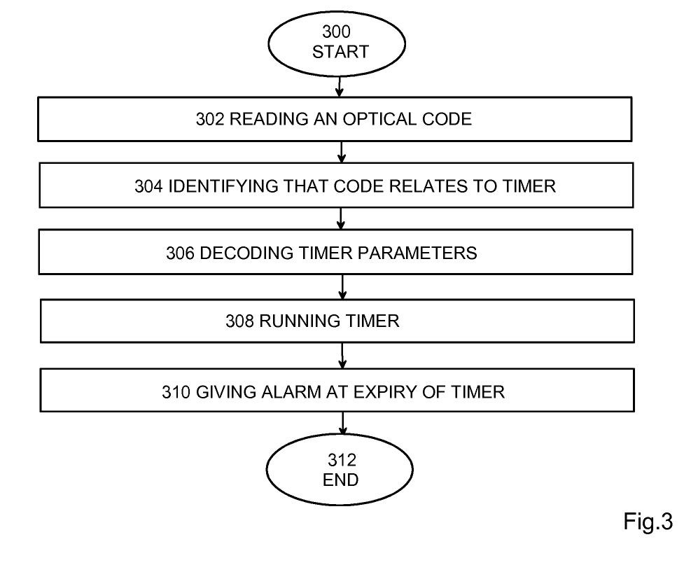

FIG. 3 shows an embodiment of a method. In 302, an optical code is read by using a mobile device suitable for being carried with a person. In 304, the device decodes the optical code and provides a set of symbols as an output of the functionality. Further in 304, the device detects, by finding a suitable symbol from the decoded data, that the code relates to a timer functionality.

In 306, further parameters in the code and needed to implement the timer may be detected from the code. These further parameters may include one or more of the following: the time of the day of the first expiry of the timer, duration (in hours, for instance) of the timer, number of repetitions of the timer, and the name of the timer, for instance. In 308, the timer is implemented. In 310, upon the expiry of the timer, the device may give an alarm. Considering the example of taking the medicine, the timer may be implemented 10 times, for instance, once for each dosage of medicine.

The embodiments provide an advantage that the timer service may be implemented locally within a mobile station and is independent of the availability of external networks or server computers, for instance. The mobile station is a device that is often carried along with the person and is thus suitable for applications such as reminding of taking a medicine.

The disclosed functionality in various embodiments may be implemented by way of a computer program product encoding a computer program of instructions for executing a computer process of the above-described method. The computer program product may be implemented on a computer program distribution medium. The computer program distribution medium may be any of the known ways of distributing software, such as a computer readable medium, a program storage medium, a record medium, a computer readable memory, a computer readable software distribution package, a computer readable signal, a computer readable telecommunication signal, and a computer readable compressed software package.

It will be obvious to a person skilled in the art that, as the technology advances, the inventive concept can be implemented in various ways. The invention and its embodiments are not limited to the examples described above but may vary within the scope of the claims.

1-20. (canceled)

21. A mobile station comprising:
a reader configured to read data representative of an optically readable code;
a detecting device configured to detect, from the data representative of the optically readable code, a timer indicator indicating that the code includes data for providing a timer on the mobile station, wherein
the detecting device is configured to detect, from the data representative of the optically readable code, one or more timer parameters including at least one parameter defining a time of the day; the mobile station further comprising
an applying device configured to apply the one or more timer parameters including at least one parameter defining a time of the day to directly define one or more expiry moments of the timer; and
a timer device configured to run a timer on the mobile station on the basis of the defined expiry moments of the timer.

22. The mobile station of claim 21, wherein
the detecting device is configured to detect, from the data representative of the optically readable code, a string of symbols; and
the detecting device is configured to detect the timer indicator and/or the one or more timer parameters from one or more predetermined positions in the string of symbols.

23. The mobile station of claim 21, further comprising:
an alarm device configured to provide a sound alarm at an expiry of the timer.

24. The mobile station of claim 21, wherein
the detecting device is configured to detect, as a timer parameter, a repetition indicator; the mobile station further comprising
a repeating device configured to repeat the timer a number of times indicated by the repetition indicator.

25. The mobile station of claim 21, further comprising:
a timer device configured to run at least two timers on the mobile station at the same time.

26. The mobile station of claim 21, wherein
the detecting device is configured to detect, as a timer parameter, a timer identifier; the mobile station further comprising:
an associating device configured to associate the timer identifier with the timer; and
an indicating device configured to indicate the timer identifier upon the expiry of the timer.

27. The mobile station of claim 21, further comprising:
a providing device configured to providing an alarm at an expiry of the timer;
a monitoring device configured to monitor an acknowledgement to the alarm;
a repeating device configured to repeat the alarm until the acknowledgement to the alarm is received.

28. The mobile station of claim 21, including for a timer operation mode applying device configured to apply a timer operation mode, in which the detecting device configured to detect from the data representative of the optically readable code, a timer indicator and one or more timer parameters, the applying device configured to define one or more expiry moments of the timer, and the timer device, are activated.

29. A method comprising:
reading an optically readable code;
detecting, from the data representative of the optically readable code, a timer indicator indicating that the code includes data for providing a timer;
detecting, from the data representative of the optically readable code, one or more timer parameters including at least one parameter defining a time of the day;
applying the one or more timer parameters including at least one parameter defining a time of the day to directly define one or more expiry moments of the timer; and
running the timer on the basis of the defined expiry moments of the timer.

30. The method of claim 29, further comprising:
detecting, from the data representative of the optically readable code, a string of symbols; and
detecting the timer indicator and/or the one or more timer parameters from one or more predetermined positions in the string of symbols.

31. The method of claim 29, further comprising:
providing a sound alarm at an expiry of the timer.

32. The method of claim 29, further comprising:
detecting, as a timer parameter, a repetition indicator; and
repeating the timer a number of times indicated by the repetition indicator.

33. The method of claim 29, further comprising:
running at least two timers at the same time.

34. The method of claim 29, further comprising:
detecting, as a timer parameter, a timer identifier; and
indicating the timer identifier upon the expiry of the timer.

35. A non-transitory computer-readable medium including a computer program product stored thereon, the computer program product comprising computer executable instructions and, when executed by an electronic device, performing the following steps:
reading an optically readable code;
detecting, from the data representative of the optically readable code, a timer indicator indicating that the code includes data for providing a timer;
detecting, from the data representative of the optically readable code, one or more timer parameters including at least one parameter defining a time of the day;
applying the one or more timer parameters including at least one parameter defining a time of the day to directly define one or more expiry moments of the timer; and
running the timer on the basis of the defined expiry moments of the timer.

36. The non-transitory computer-readable medium of claim 35, wherein the computer program product further comprises computer executable instructions for:
detecting, from the data representative of the optically readable code, a string of symbols; and
detecting the timer indicator and/or the one or more timer parameters from one or more predetermined positions in the string of symbols.

37. The non-transitory computer-readable medium of claim 35, wherein the computer program product further comprises computer executable instructions for:
providing a sound alarm at an expiry of the timer.

38. The non-transitory computer-readable medium of claim 35, wherein the computer program product further comprises computer executable instructions for:
detecting, as a timer parameter, a repetition indicator; and
repeating the timer a number of times indicated by the repetition indicator.

39. The non-transitory computer-readable medium of claim 35, wherein the computer program product further comprises computer executable instructions for:
running at least two timers at the same time.

40. The non-transitory computer-readable medium of claim 35, wherein the computer program product further comprises computer executable instructions for:
detecting, as a timer parameter, a timer identifier; and
indicating the timer identifier upon the expiry of the timer.
